(19) United States
(12) Patent Application Publication
(10) Pub. No.: US 2015/0320243 A1
(43) Pub. Date: Nov. 12, 2015

(54) VEGETABLE GROWTH SUPPORT DEVICE

(71) Applicant: Shimon BERGERBEST, (US)

(72) Inventor: Shimon Bergerbest, Kfar Saba (IL)

(21) Appl. No.: 14/654,600

(22) PCT Filed: Dec. 23, 2013
(86) PCT No.: PCT/IL2013/051050

§ 371 Date: Jun. 22, 2015

(30) Foreign Application Priority Data
Dec. 24, 2012 (IL) 223846

(51) Int. Cl. A47G 7/02; F16B 2/10; F16M 13/02

(52) U.S. Cl. CPC A47G 7/02; F16M 13/022; F16B 2/10

(57) ABSTRACT

The invention relates to a vegetable-growth device, comprising one or more supporting beams, one or more connecting elongated elements and one or more locking elements. Each supporting beam is provided with one or more recessed portions, each recessed portion having at least one slanted surface. The shape of the connecting elongated members is suitable to be housed within the recessed portion, wherein said portion is suitable to prevent an elongated member housed therein from easily disengaging therefrom. The extremity of the elongated members can be hollow, or suitable to combine with a female or with a male capping ends.

### FIELD OF THE INVENTION

The present invention relates to the field of vegetable growth. More particularly, the invention relates to a device that is adjustable and better suited to any kind of environment, regardless of whether it is placed indoors or out.

### BACKGROUND OF THE INVENTION

Vegetable growth, particularly for environmental and architectural purposes, is very common in domestic, public and even business surroundings. In many cases, it is preferred to place planting containers at a distance from the floor, and that can be achieved, for instance, by hanging planters, or by using furniture as a supporting surface.

Nowadays, it is customary to hang planters by a chain with a hook-shaped edge, attached to the planter and held by a peg or the like. Another option is placing the planters upon a shelf or a surface of furniture. When using such methods, the options are limited according to different constraints of the room. In addition, there are some structures that allow the hanging of planters but restrict the use to a certain shape, size and placement, or require a complex assembly process. Two examples are described in U.S. Pat. No. 8,132,366 and U.S. Pat. No. 7,832,147.

To date, the prior art has failed to provide an efficient device and method for designing vegetable growth structure. It is an object of the present invention to provide a device that overcomes the drawbacks of the prior art, particularly concerning shape, size and placement of both planter and structure.

Other objects and advantages of the invention will become apparent as the description proceeds.

### SUMMARY OF THE INVENTION

The invention relates to a vegetable-growth device, comprising one or more supporting beams, one or more connecting elongated elements and one or more locking elements. Each supporting beam is provided with one or more recessed portions, each recessed portion having at least one slanted surface. The shape of the connecting elongated members is suitable to be housed within the recessed portion, wherein said portion is suitable to prevent an elongated member housed therein from easily disengaging therefrom. The extremity of the elongated members can be hollow, or suitable to combine with a female or with a male capping ends.

According to one embodiment of the invention, the locking element comprises an eccentric member. Alternatively, the locking element is adapted to produce pressure on the elongated member while said elongated member housed within recessed portions.

According to an embodiment of the invention, the supporting beam further comprises an end unit that is provided with a clip-like arrangement adapted for grasping a rail frame of an essentially flat structure and thereby to hang the vegetable-growth device on said essentially flat structure.

In another aspect the invention relates to a modular vegetable-growth system, which comprises two or more supporting beams and a plurality of connecting elongated members, wherein one or more supporting beams are connectable to a supporting surface. According to an embodiment of the invention, the supporting beams and the elongated elements can be of different lengths.

In another aspect the invention relates to a clip-like arrangement suitable to be hung on a rail frame of a fence, comprising: a) two clamping members that are adapted to clasp the rail of the fence from both sides of said fence, wherein the first clamping member having an opening adapted to receive a corresponding hanging bar, and the second clamping member having an opening adapted to receive and anchor said corresponding hanging bar within its inner space; b) a hanging bar having a curved end with an inclined tip for creating an anchor effect, wherein said curved end is adapted to be inserted at first through the corresponding opening of said first clamping member and then through the corresponding opening of said second clamping member, until said inclined tip becomes anchored within the inner space of said second clamping member, thereby said hanging bar connects both clamping member together; and c) one or more screws for tightening the grasping of the two clamping members around said rail.

According to an embodiment of the invention, the clip-like arrangement further comprises a mediating member for allowing hanging any suitable object on the fence, by allowing assembling said object to the hanging bar. The objects can be not only the vegetable-growth device of the present invention, but also any other type of suitable object to be hung such as flowerpots, planters, etc.

### BRIEF DESCRIPTION OF THE DRAWINGS

In the drawings:

FIG. 1 is a perspective view of a beam provided with niches along its length, according to one embodiment of the invention;

FIG. 2A shows a front view of the beam of FIG. 1, 1 also showing lock members;

FIG. 2B shows a side view of the beam of FIG. 1, also showing lock members;

FIG. 2C shows a detailed view of a lock member in an open state, according to an embodiment of the present invention;

FIG. 2D shows a detailed view of a lock member in a close state, according to an embodiment of the present invention;

FIG. 3A is a perspective of a connecting elongation member of a shape compatible with the niches shown in FIG. 1;

FIG. 3B is a front view of the connecting elongation member of FIG. 3A;

FIG. 4A shows a supporting unit, according to an embodiment of the present invention;

FIG. 4B shows the connection of the supporting unit of FIG. 4A to a beam;

FIGS. 5A and 5B show end units, according to some embodiments of the present invention;

FIGS. 6A and 6C show a planter, with hanging means, suitable for use with the invention;

FIGS. 6B and 6D show another planter, with hanging means, suitable for use with the invention;

FIG. 7 illustrates the use of beams and connecting elongation members of various lengths;

FIG. 8 also shows the use of connecting elongation members of various lengths;

FIGS. 9A-9D show an end unit, with a screw that provides height adjustment;

FIGS. 10A and 10B show a structure, according to one embodiment of the invention wherein the end unit is provided with a hook-shaped end suitable for hanging on a wall;

FIG. 11 is a perspective view of a beam connected to a supporting unit;

FIGS. 12 and 13 schematically illustrate a structure, according to another embodiment of the invention, wherein the end unit is provided with a clip-like arrangement suitable for hanging on top of a glass fence;

FIGS. 14A-14C schematically illustrate the clip-like arrangement, according to an embodiment of the invention; and

FIGS. 15A and 15B schematically illustrate a locking method of the elongated member to the beams, according to an embodiment of the invention.

### DETAILED DESCRIPTION OF THE INVENTION

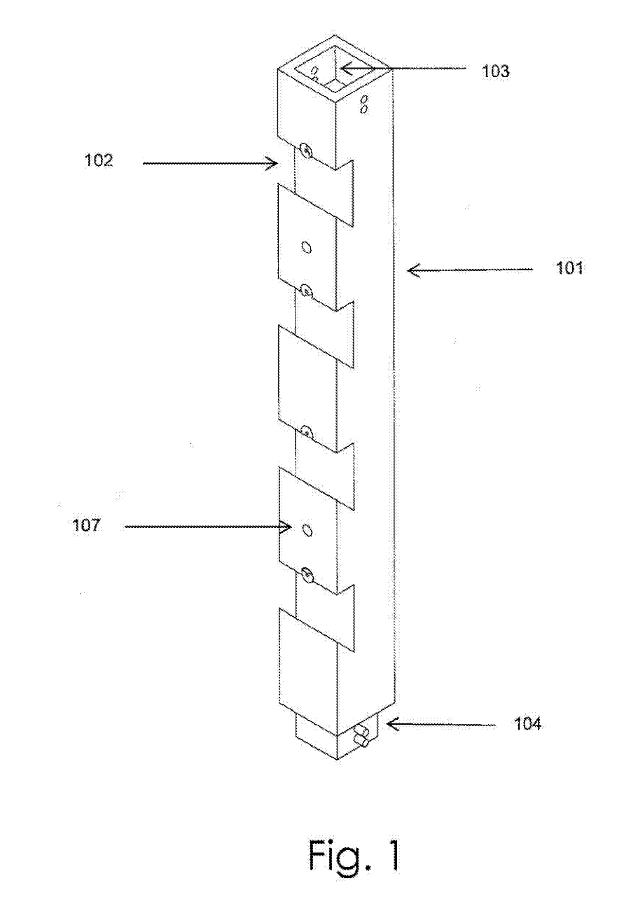

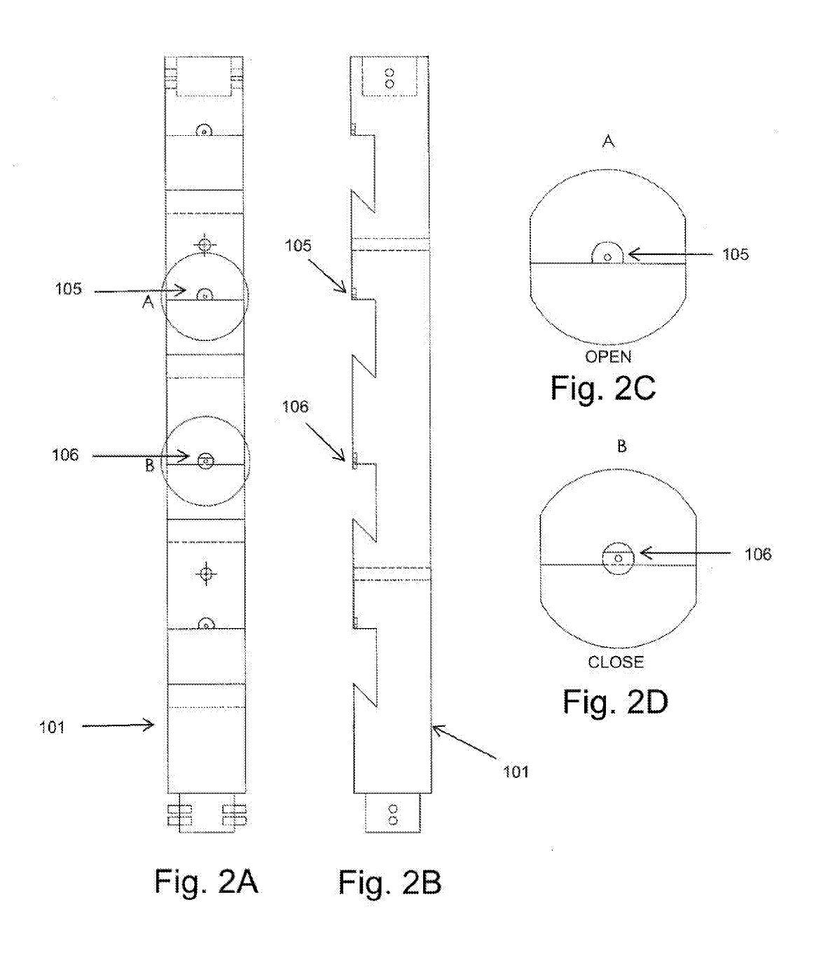

The invention allows freedom of creation, which can be obtained by a modular structure of a vegetable-growth device, giving the user the possibility to fit the shape and size of the structure, according to the desired environment. In FIG. 1, a beam 101 has one or more recessed portions provided along its length such as indicated by niche 102. The female connection 103 and male connection 104 are an example of a suitable connecting mechanism between two beams, wherein 104 and 103 are locked by pins. Screws 107 provided along the beam 101 allow the hanging of the structure on a wall, simply by affixing them to the wall. In FIGS. 2A and 2B the same beam 101 is seen in a front and side view, respectively. Locking elements 105, 106 are connected to beam 101 and are adapted to be rotated into an open state or lock state. In this example, locking element 105 is in an open state (see FIG. 2C) and locking element 106 is in a closed state (see FIG. 2D).

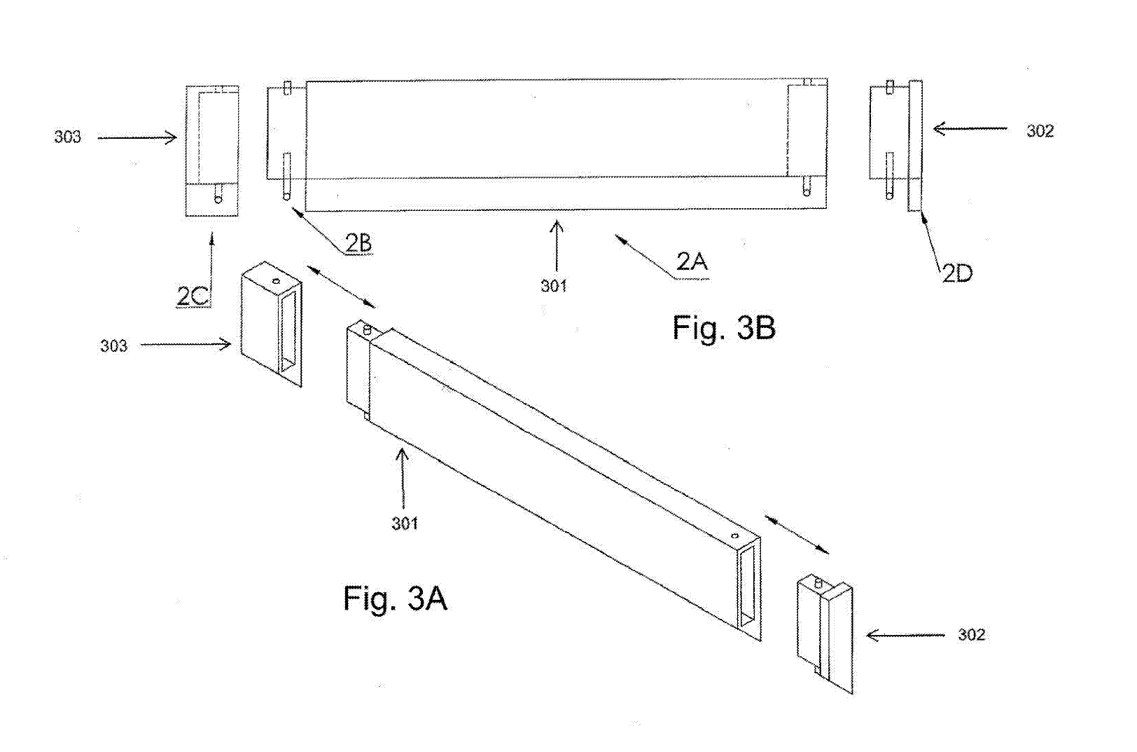

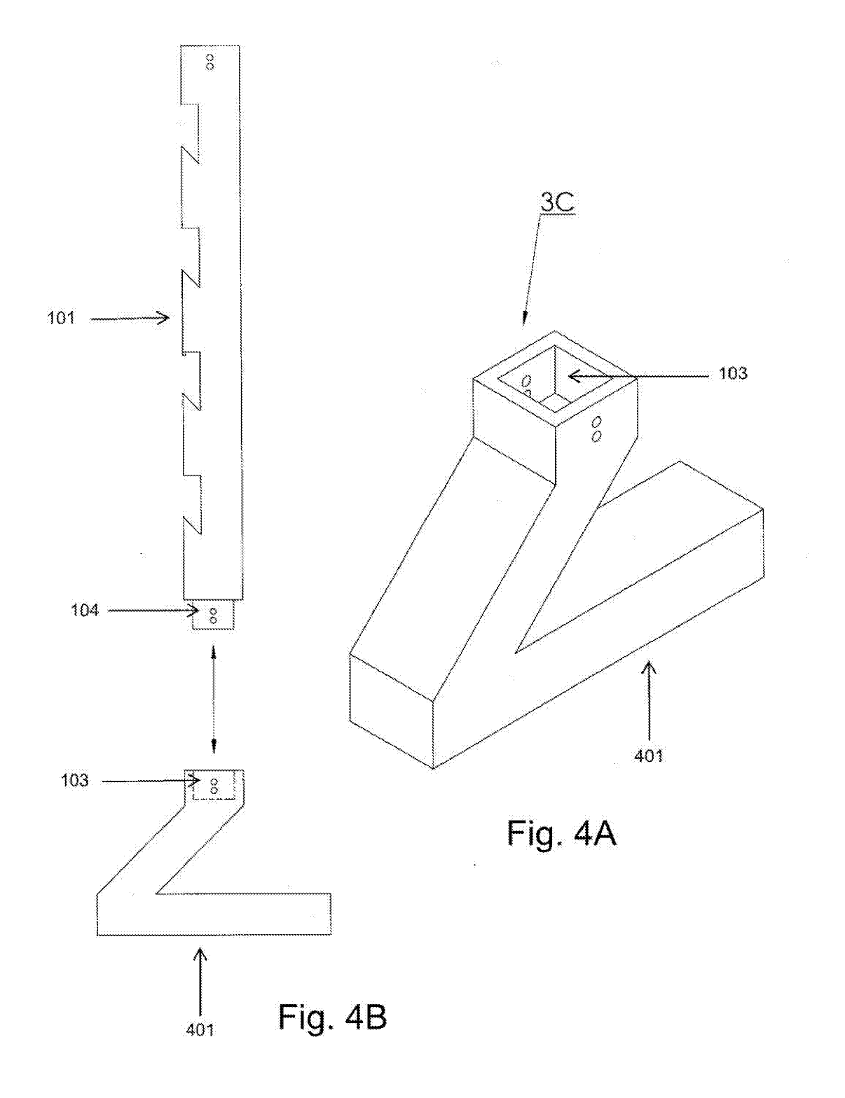

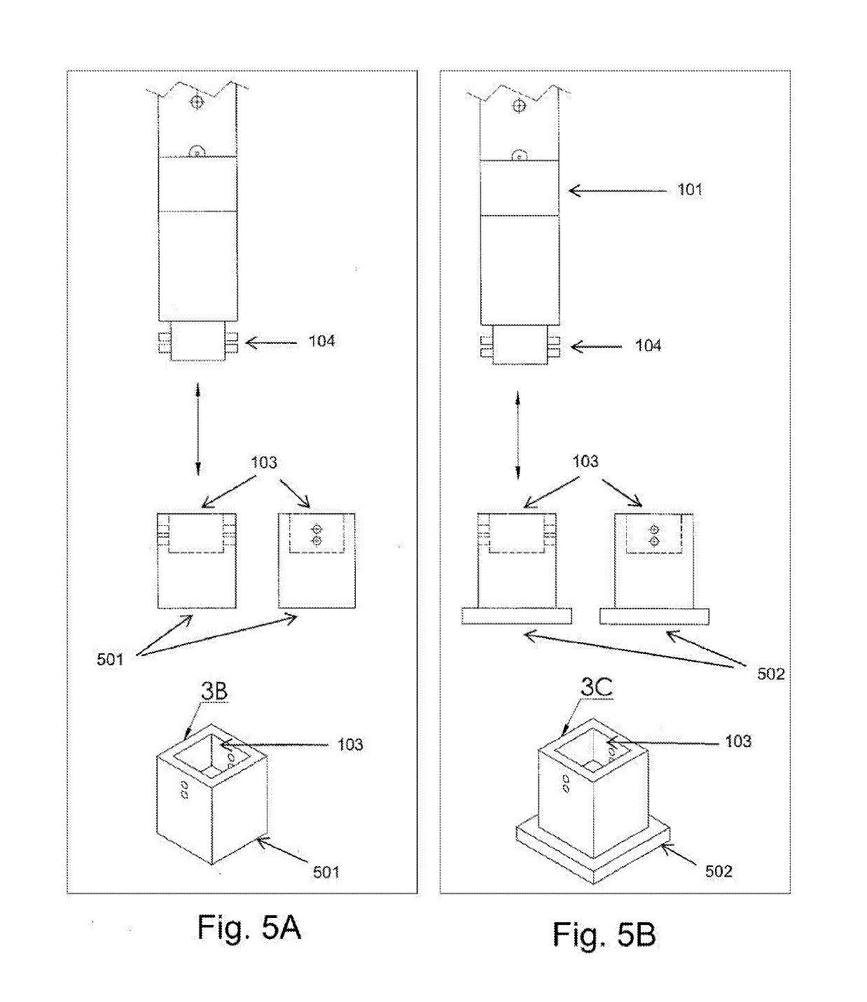

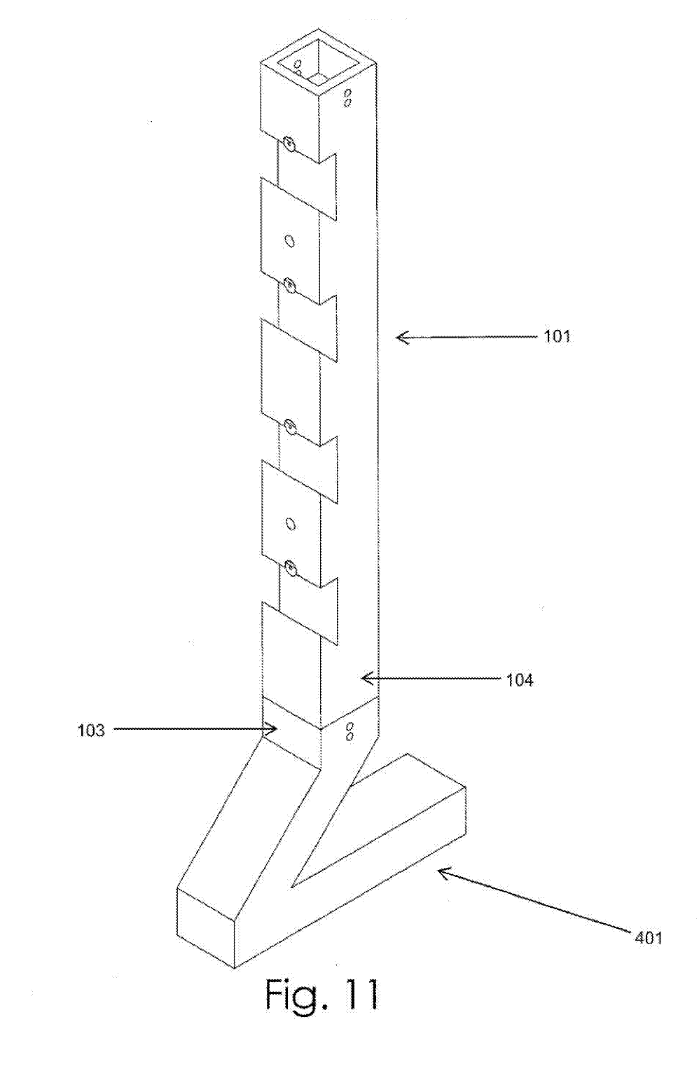

FIGS. 3A and 3B show a shape of an alternative connecting elongated member 301, fit to engage the recessed portions (i.e., the niches 102) of two or more parallel beams 101. End units 302 and 303 cap the connecting elongated member 301, similarly to connections 103 and 104. In FIGS. 4 and 11, the beam 101 is connected to an end unit 401 which also functions as a stand that stably supports the beam 101. The end unit 401 is also provided with female connection 103 and male connection 104 of the beam, and may be further locked into position with it using suitable locking means (not shown). In FIGS. 5A and 5B the end unit is used as a base. It can be an end unit with a narrow base 501 (as shown in FIG. 5A) or an end unit with a wider base 502 (as shown in FIG. 5B), and the beam 101 is connected to those bases by the connectors 103 and 104.

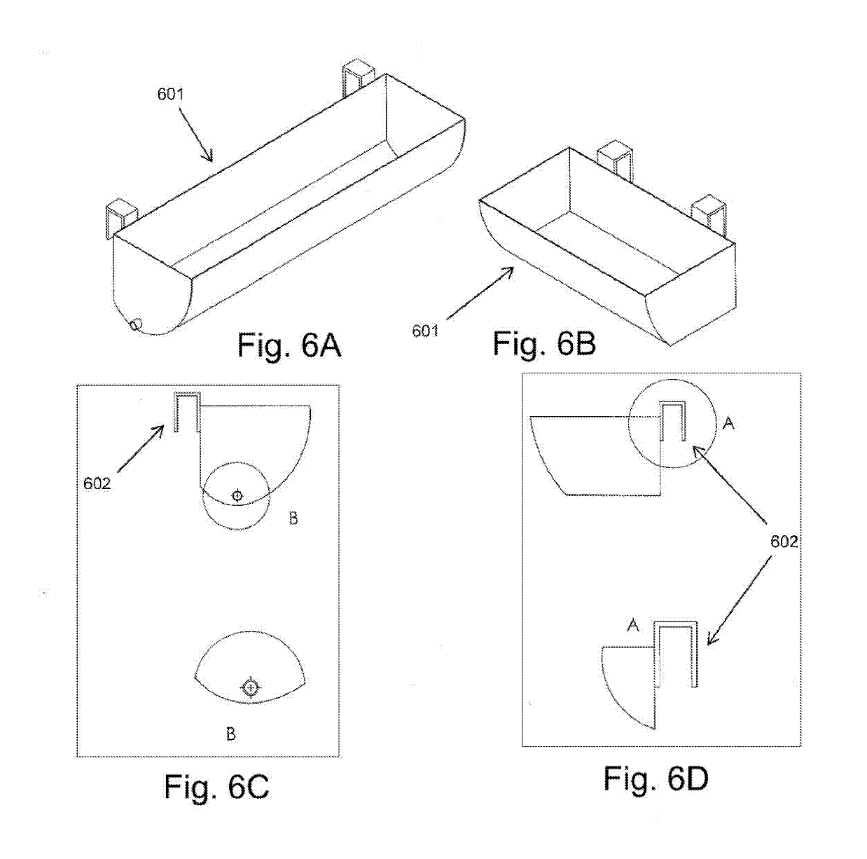

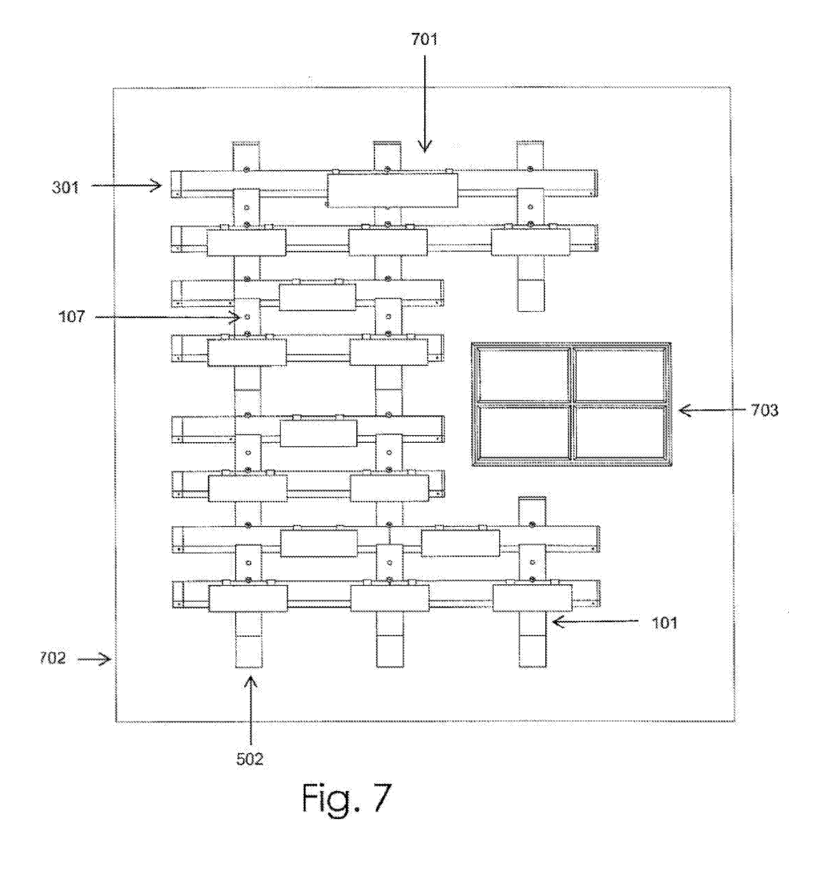

FIGS. 6A and 6B show perspective views of planters 601, which can be of in different sizes and shapes, which are provided with hanging means 602, suited to be hung on the elongated member 301 or a beam. FIGS. 6C and 6D show a side view of the planters 601 of FIGS. 6A and 6B, respectively. Optionally, other objects can also be hung with hanging means 602, such as one or more shelves. FIG. 7 illustrates the modularity of the structure 701 and the use of different lengths of beams 101 and connecting elongated members 301 in the same structure. The environmental restrictions shown in this figure comprise a wall 702 and a window 703, which the modularity of the structure 701 can overcome, by using a screw 107 to attach the structure 701 to the wall 702.

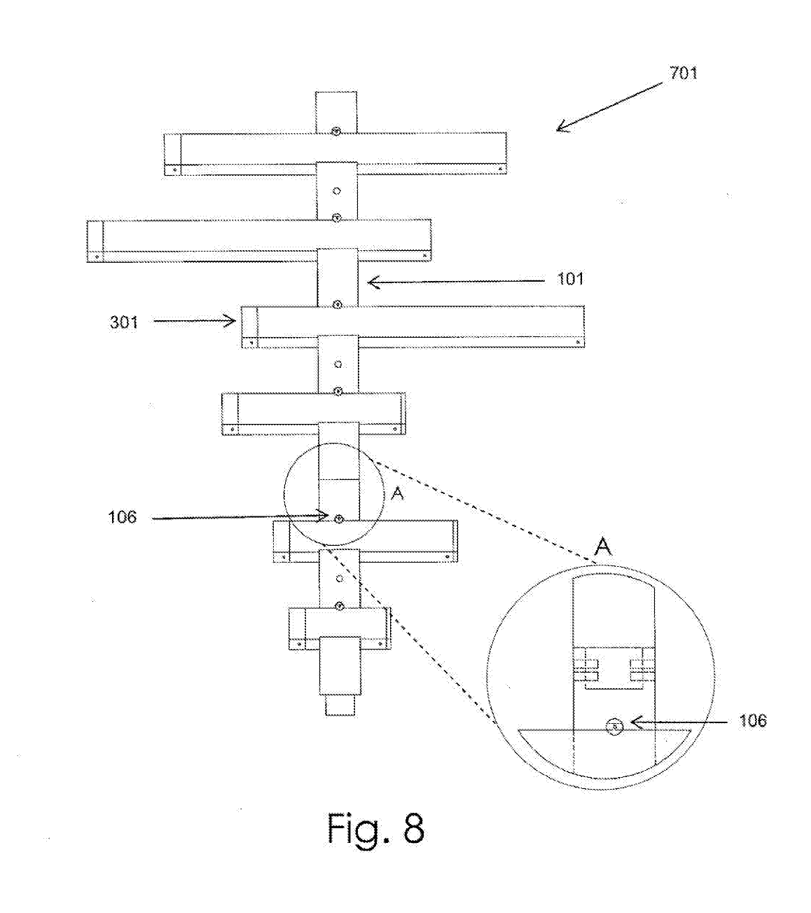

FIG. 8 is another example of the modularity of the structure. Locking element 106 is shown at its closed state, and different lengths of connecting elongated members 301 comprise the structure 701.

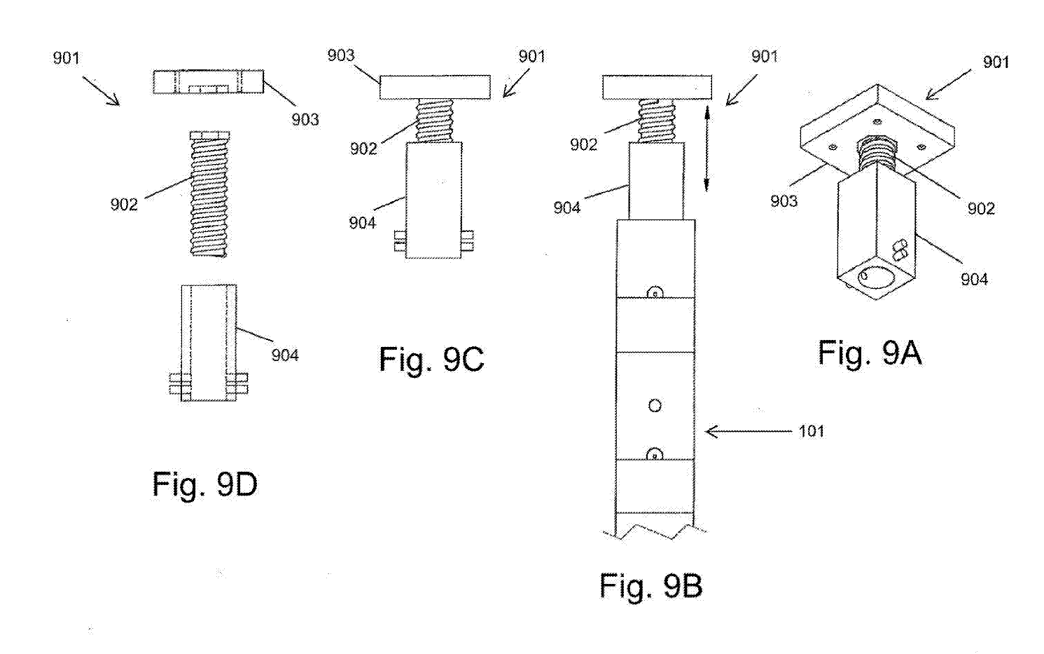

FIGS. 9A-9D show an end unit 901 provided with a screw 902 suitable to generate pressure between the beam 101 and the surface with which it is in contact thereby to stabilize the structure. The end unit 901 with the screw 902 provides height adjustment by turning the screw 902 clockwise or counterclockwise. FIG. 9A shows a perspective view of the end unit 901. FIG. 9B shows the end unit 901 connected to the beam 101. FIG. 9C shows a side view of the end unit 901. FIG. 9D shows the different parts of the end unit 901 that includes a base 903, the screw 902 and the end's unit body 904 which adapted to receive the screw 902.

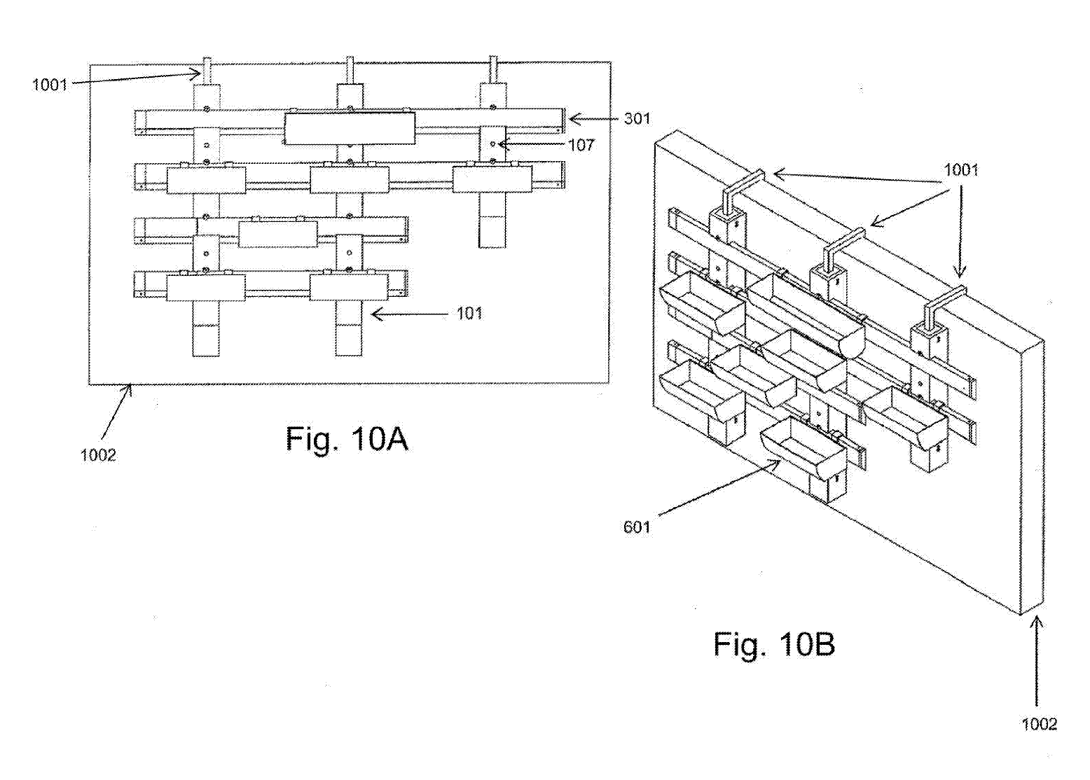

FIGS. 10A and 10B show a structure with end units 1001, which can conveniently be hung on a wall 1002, a rail, a pole and the like. This figure also illustrates the hanging of the planters 601 on the connecting elongation members 301 and the fixation of the beams 101 on the wall 1002 by screws 107.

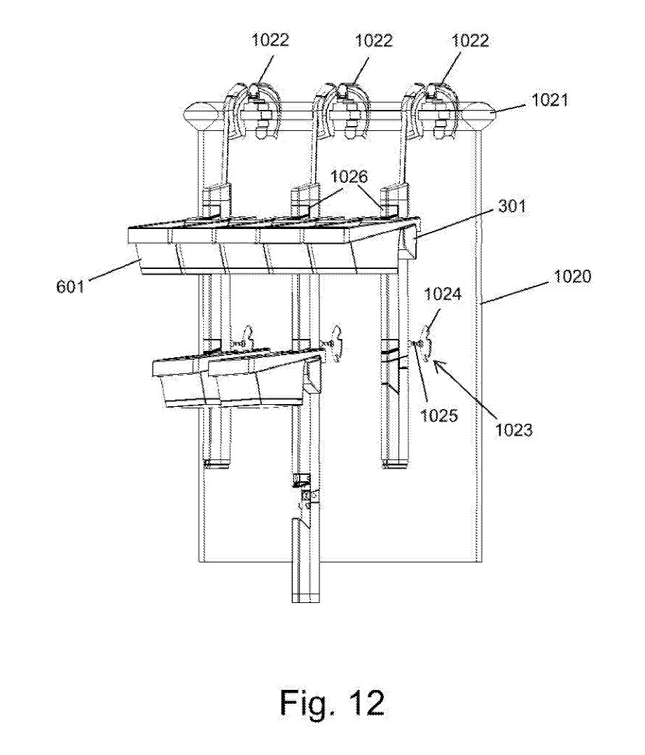

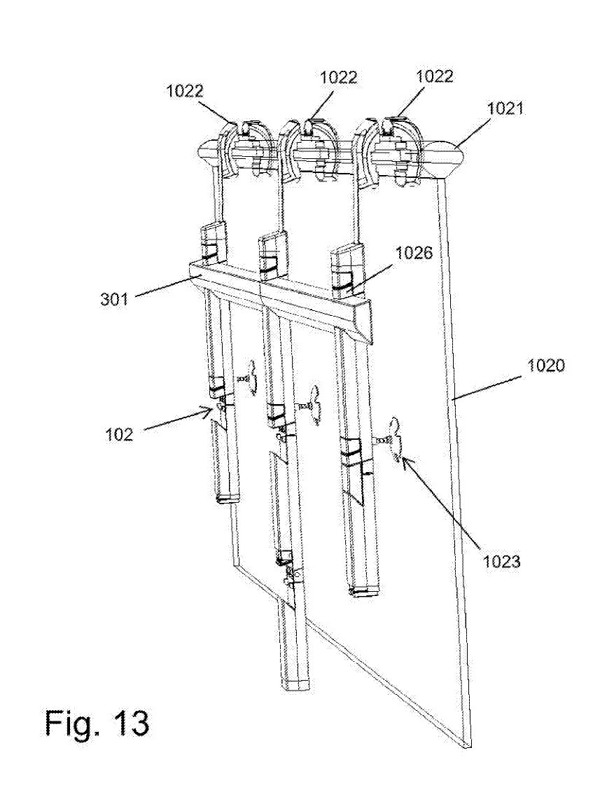

FIG. 12 schematically illustrates a structure with end units, which can conveniently be hung on top of a fence such as a common balcony's glass fence 1020 and the like. This figure also illustrates the hanging of the planters 601 on the connecting elongated members 301 and the alignment of the beams 101 with respect to the plane of the glass fence 1020 by one or more alignment members 1023 that act also as a spacer. FIG. 13 schematically illustrates the structure of FIG. 12 without the planters. In this embodiment, the end unit is provided with a clip-like arrangement 1022 adapted for grasping the rail 1021 of the glass fence 1020, and thereby conveniently be hung on the glass fence 1020 in a fixation and secure manner. At least one alignment member 1023 is connected to the rear side of each of the beams 101. According to an embodiment of the invention, the alignment member 1023 includes a rod 1025 that is essentially perpendicular to the beam 101 and a glass supporting element 1024. The rod 1025 may have a fixed length or its length can be adjusted (e.g., in a screw-like manner). The glass supporting element 1024 has a flat surface adapted to be pressed against the flat surface of the glass fence 1020. In one embodiment, the glass supporting element 1024 is provided in form of a suction cup suitable for enhancing the fixation of the beams 101 to the flat surface of the glass fence 1020. The alignment members 1023 can be used to set the incline of the beams 101, e.g., in cases where the thickness of the rail 1021 of the glass fence 1020 is wider than the thickness of the glass.

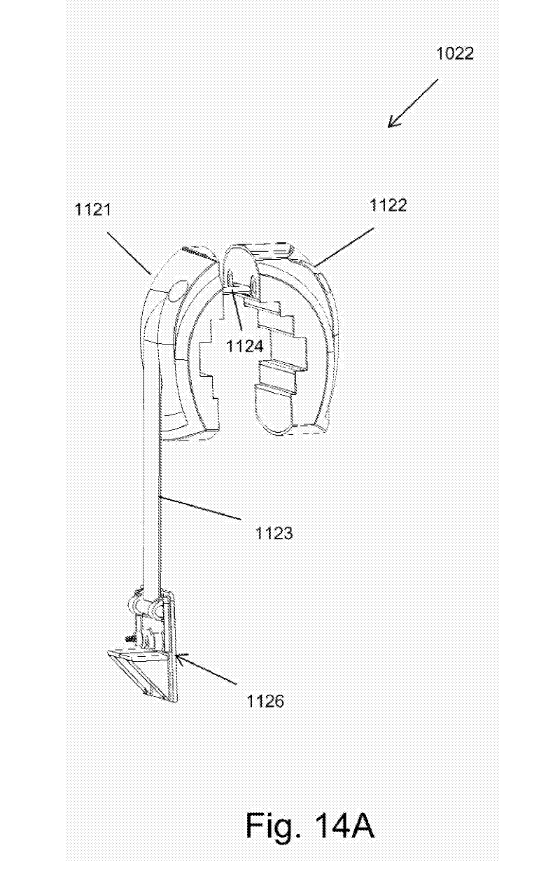

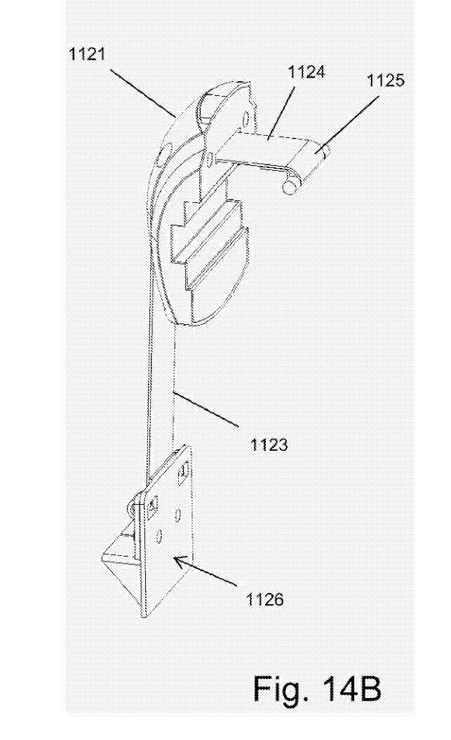

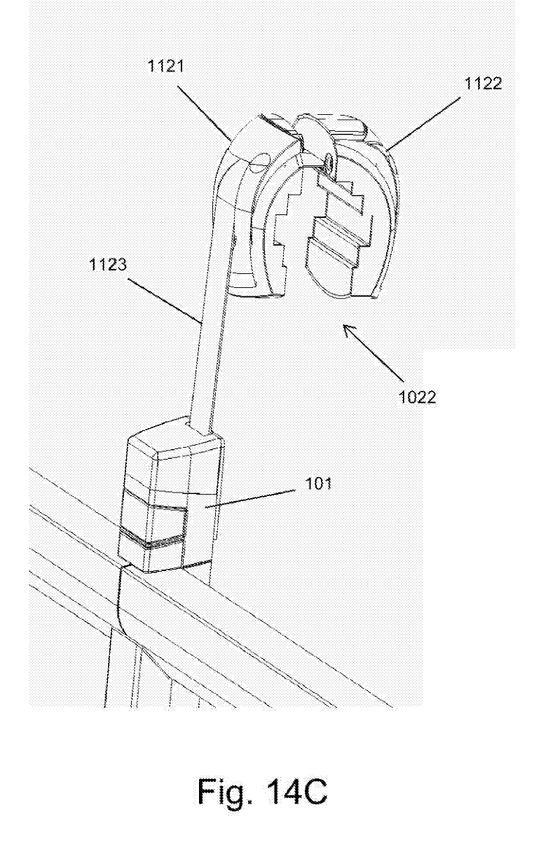

FIGS. 14A-14B schematically illustrate the clip-like arrangement 1022 in further details, according to an embodiment of the invention. The clip-like arrangement 1022 includes two clamping members 1121 and 1122 that are adapted to clasp or grasp a rail of a fence, for example, as shown by the rail 1021 of fence 1020 in FIGS. 12 and 13. The inner side of each clamping member (i.e., the side that face the fence) is adapted to fit the outer form of the rail 1021. The clip-like arrangement 1022 also includes a hanging bar 1123 having a curved end 1124 with an inclined tip 1125 (see FIG. 14B) for creating an anchor effect that connects both clamping member together. The curved end 1124 is inserted through corresponding openings in the clamping members 1121 and 1122, until the inclined tip 1125 becomes anchored by an inner structure of the clamping member 1122 that corresponds to the structure of the inclined tip 1125. In addition, one or more screws can be used to tighten the grasping of the clamping members 1121 and 1122 around the rail 1021 of fence 1020 as well as to secure them to one another.

The other end hanging bar 1123 can be used to fit and connect to plurality of objects to be hung thereon, such as planter, flowerpots, and the like. For example, as shown in FIG. 14C, a mediating member 1126 can be used to connect the other end of the hanging bar 1123 to the beam 101. This can be implemented by any suitable connecting means, such as snap fitting, screws, etc.

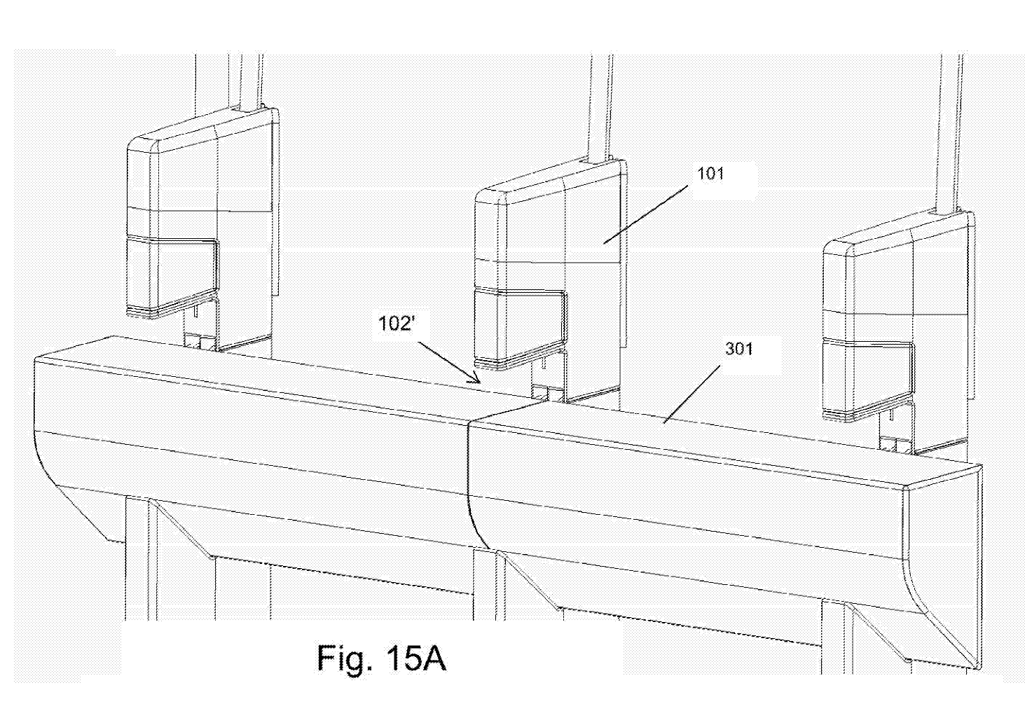

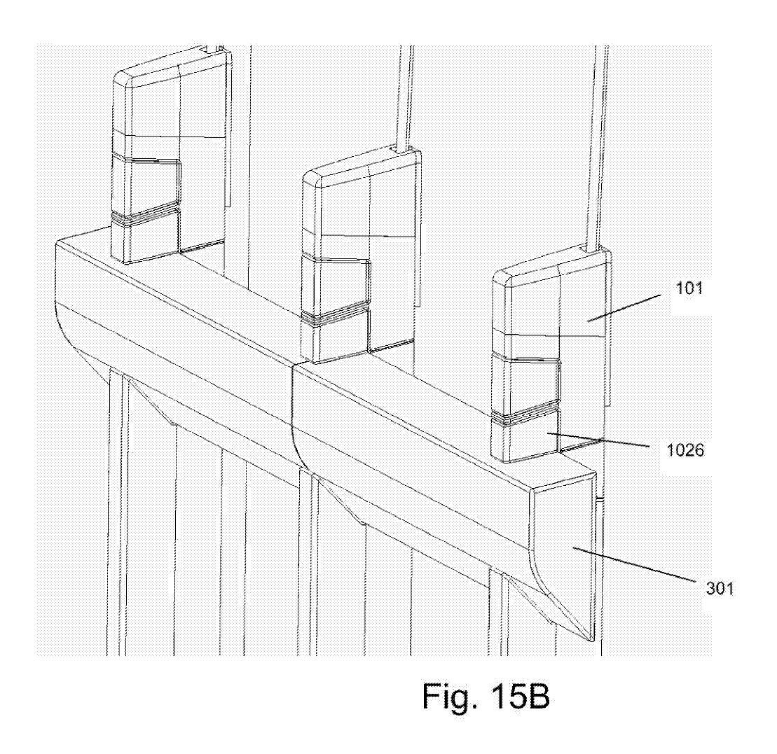

According to an embodiment of the invention, the modular structure includes one or more locking elements 1026 associated with the recessed portions 102, suitable to prevent the elongated member 301 housed therein from easily disengaging therefrom, as schematically illustrated in FIGS. 12 and 13. For example, the locking element 1026 may act as a wedge that upon its insertion into the gap that remains between the beam 101 and the elongated member 301 (as indicated by numeral 102′ in FIG. 15A), it produces pressure on the elongated member 301. Alternatively, the locking element 1026 locks or secures the elongated member 301 to the beam 101 by using a snap fitting technique that provides a simple and rapid means of assembling plastic parts. For example, a molded undercut on the locking element 1026 engages a mating lip on the beam 101 (not shown). FIG. 15B shows the locking element 1026 in its locking position that completely fills the gap 102′ that is shown in FIG. 15A.

All the above description has been provided for the purpose of illustration and is not meant to limit the invention in any way. The invention presents significant advantages over the existing prior art. For example, the modularity of the structure, the variety of the shapes and the simplicity of the assembly.

1. A vegetable-growth device, comprising:
a) One or more supporting beams, wherein each supporting beam is provided with one or more recessed portion(s), each recessed portion having at least one slanted surface;
b) One or more connecting elongated elements having a shape suitable to be housed within said recessed portion; and
c) One or more locking elements associated with said recessed portions, suitable to prevent an elongated member housed therein from easily disengaging therefrom.

2. A device according to claim 1, wherein the locking element comprises an eccentric member.

3. A device according to claim 1, wherein the locking element is adapted to produce pressure on the elongated member while said elongated member housed within recessed portions.

4. A device according to claim 1, wherein the connecting elongated elements are hollowed at least one extremity.

5. A device according to claim 4, further comprising a male capping element.

6. A device according to claim 4, wherein at least one extremity ends in a male connecting portion.

7. A device according to claim 6, further comprising a female capping element.

8. A device according to claim 1, wherein the supporting beam having an end unit that is provided with a clip-like arrangement adapted for grasping a rail frame of an essentially flat structure and thereby to hang said device on said essentially flat structure.

9. A modular vegetable-growth system, comprising two or more supporting beams and a plurality of connecting elongated members, wherein one or more supporting beams are in contact with a supporting surface, and wherein each supporting beam is provided with one or more recessed portion(s), each recessed portion having at least one slanted surface.

10. A system according to claim 9, comprising supporting beams and/or elongated elements of different lengths.

11. A clip-like arrangement suitable to be hung on a rail frame of a fence, comprising:
a) two clamping members that are adapted to clasp the rail of the fence from both sides of said fence, wherein the first clamping member having an opening adapted to receive a corresponding hanging bar, and the second clamping member having an opening adapted to receive and anchor said corresponding hanging bar within its inner space;
b) a hanging bar having a curved end with an inclined tip for creating an anchor effect, wherein said curved end is adapted to be inserted at first through the corresponding opening of said first clamping member and then through the corresponding opening of said second clamping member, until said inclined tip becomes anchored within the inner space of said second clamping member, thereby said hanging bar connects both clamping member together; and
c) one or more screws for tightening the grasping of the clamping members around said rail.

12. A clip-like arrangement according to claim 11, further comprising a mediating member for allowing hanging any suitable object on the fence, by allowing assembling said object to the hanging bar.
